(19) United States
(12) Patent Application Publication
(10) Pub. No.: US 2007/0173298 A1
(43) Pub. Date: Jul. 26, 2007

(54) Keypad assembly

(76) Inventor: Chien-Kuo Tang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/332,361

(22) Filed: Jan. 17, 2006

(51) Int. Cl. H04M 1/00

(52) U.S. Cl. 455/575.1

(57) ABSTRACT

A keypad assembly is mounted on a substrate of a cellular phone and has a metal sheet, a base sheet and a template. The metal sheet has a bottom and a top. The base sheet is mounted on the bottom of the metal sheet. The template is mounted on the top of the metal sheet and can be modified or decorated so cellular phone manufacturers can do some extra work on the template. The cellular phone with the template of the keypad assembly can improve the appearance and increase the value of the cellular phone.

### BACKGROUND OF THE INVENTION

1. Field of the Invention

The present invention relates to a keypad assembly for a cellular phone, and more particularly to a keypad assembly that can be modified and decorated.

2. Description of Related Art

Most wireless communication apparatuses provide people a better life and better communication. Cellular phones are the best example of wireless communication apparatuses. Cellular phones have greatly decreased in size. To reduce the size of cellular phones, all parts of the cellular phones have been changed and more particularly cellular phone keypad assemblies.

With reference to FIG. 3, a conventional keypad assembly for a cellular phone is mounted on a substrate (60) of a cellular phone and comprises a metal sheet (50), a membrane (52), a luminescent layer (53) and a plastic base (54).

The metal sheet (50) has a top, a bottom and multiple keys (51). The top of the metal sheet (50) is a shiny metal surface. The keys (51) are formed separately on the metal sheet (50).

The membrane (52), the luminescent layer (53) and plastic base (54) are mounted sequentially on the bottom of the metal sheet (50). The plastic base (54) has a bottom and multiple protrusions (541). The protrusions (541) are formed on the bottom of the plastic base (54), correspond to the keys (51) of the metal sheet (50) and abut protruding electrical contacts on the substrate (60).

The protrusions (541) press the corresponding protruding electrical contacts on the substrate (60) when the keys (51) are pressed, which activate the luminescent layer (53) and the substrate (60) of the cellular phones.

Because the top of the metal sheet (50) is a shiny metal surface, the top of the metal sheet (50) is very difficult to modify and decorate. The shiny metal surface of the metal sheet (50) reduces cellular phones value and appearance.

To overcome the shortcomings, the present invention provides a keypad assembly to obviate or mitigate the aforementioned problems.

### SUMMARY OF THE INVENTION

The primary objective or the present invention is to provide a keypad assembly that can be modified and decorated.

The keypad assembly is mounted on a substrate of a cellular phone and has a metal sheet, a base sheet and a template. The metal sheet has a bottom and a top. The base sheet is mounted on the bottom of the metal sheet. The template is mounted on the top of the metal sheet and can be modified and decorated so cellular phone manufacturers can do extra work on the template. The cellular phone with the template can improve the appearance and increase the value of the cellular phone.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a keypad assembly in accordance with the present invention;

FIG. 2 is a cross sectional side view of the keypad assembly in FIG. 1; and

FIG. 3 is a cross sectional side view of a conventional keypad assembly for a cellular phone in accordance with the prior art.

### DETAILED DESCRIPTION OF THE PREFERRED EMBODIMENTS

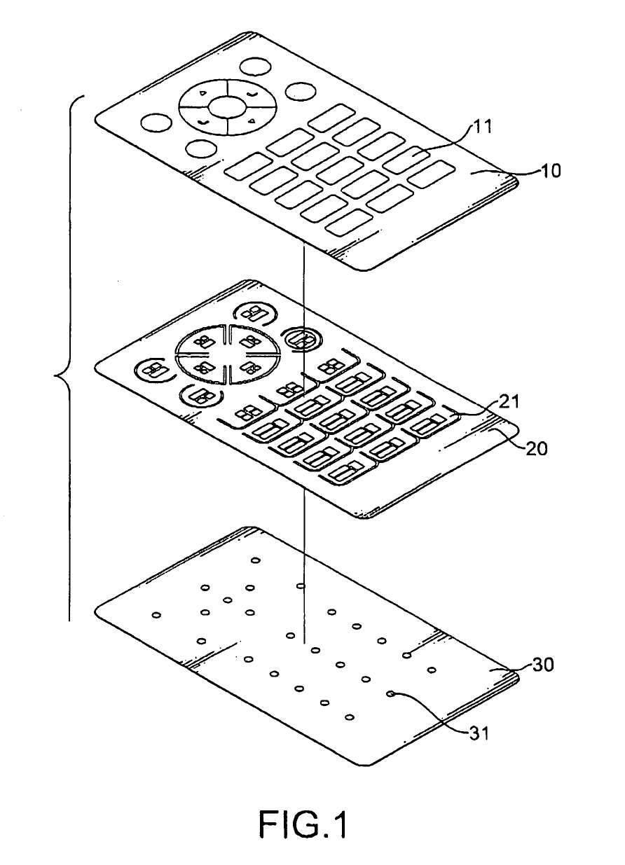

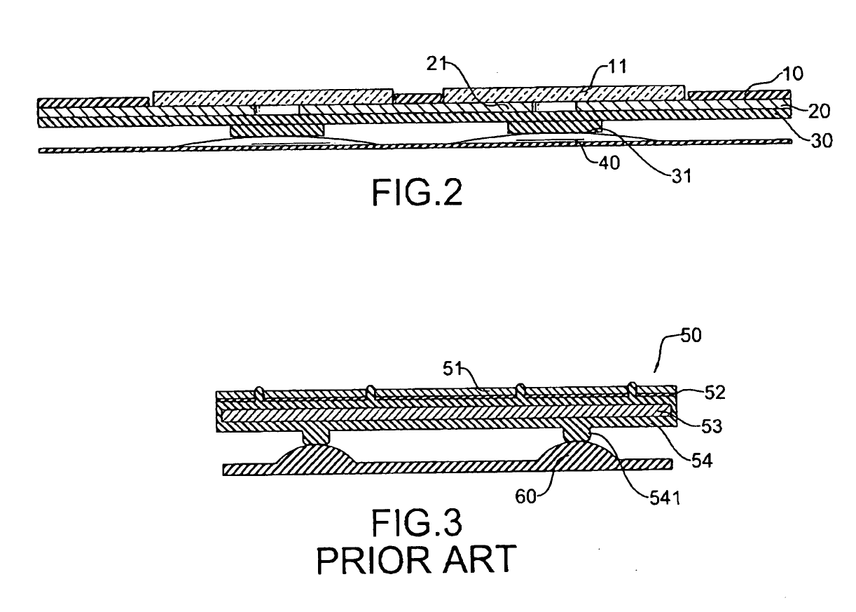

With reference to FIGS. 1 and 2, a keypad assembly in accordance with the present invention is mounted on a substrate (40) of a cellular phone and comprises a metal sheet (20), a template (10) and base sheet (30). The substrate (40) has a top surface and multiple contacts. The contacts are formed on and protrude from the top surface of the substrate (40).

The metal sheet (20) is resilient and has a top, a bottom and multiple keys (21). The keys (21) are formed on the metal sheet (20).

The template (10) is made of plastic, modifications and decorations, is mounted on the top of the metal sheet (20) and has multiple optional keyholes and multiple optional key stickers (11). The keyholes are formed through the template (10) and correspond respectively to the keys (21) on the metal sheet (20). The key stickers (11) are in the keyholes of the template (10) and stick on the keys (21) of the metal sheet (20).

The base sheet (30) is mounted on the bottom of the metal sheet (20) and has a bottom and multiple protrusions (31). The protrusions (31) are formed on the bottom of the base sheet (30), correspond respectively to the keys (21) of the metal sheet (20) and press respectively against the contacts on the substrate (40).

When the key stickers (11) of the template (10) are pressed, the keys (21) of the metal sheet (20) are also pressed. The corresponding protrusions (31) on the base sheet (30) press respectively against the contacts on the substrate (40) cause the cellular phone to function.

Because the template is made of plastic, the template (10) can be easy to modify. Cellular phone manufacturers can do some extra work on the template (10). The cellular phone with the template (10) of the keypad assembly improves the appearance and increases the value of the cellular phone.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A keypad assembly to be mounted on a substrate of a cellular phone, the substrate having a top surface and multiple contacts on the top surface, and the keypad assembly comprising
a metal sheet being resilient and having
a top;
a bottom; and
multiple keys formed on the metal sheet;
a template being made of plastic and mounted on the top of the metal sheet; and
a base sheet being mounted on the bottom of the metal sheet and having
a bottom; and
multiple protrusions formed on the bottom of the base sheet, corresponding respectively to the keys of the metal sheet and adapted for pressing respectively against the contacts on the substrate.

2. The keypad assembly as claimed in claim 1, wherein the template further has
multiple keyholes formed through the template and corresponding respectively to the keys of the metal sheet; and
multiple key stickers mounted in the keyholes of the template and sticking respectively on the keys of the metal sheet.
